(19) United States
(12) Patent Application Publication
(10) Pub. No.: US 2016/0372959 A1
(43) Pub. Date: Dec. 22, 2016

(54) Wireless Power Transmitter, Charging Dock and Speaker System

(71) Applicant: ZAGG Intellectual Property Holding Co. Inc., Midvale, UT (US)

(72) Inventor: Paul Faerber, Pleasant Grove, UT (US)

(21) Appl. No.: 15/181,961

(22) Filed: Jun. 14, 2016

Related U.S. Application Data
(60) Provisional application No. 62/180,540, filed on Jun. 16, 2015.

(51) Int. Cl. H02J 7/02; H02J 50/40; H04M 1/725; H05B 37/02; H04R 1/02; H02J 50/20; H02J 7/00

(52) U.S. Cl. CPC H02J 7/025; H02J 50/20; H02J 50/40; H02J 7/027; H02J 7/0044; H05B 37/0272; H04R 1/026; H04M 1/72533; H04R 2420/07

(57) ABSTRACT

A wireless charging system has a wireless power transmitter plugged into a power outlet and capable of sending energy via a signal. A charging dock, a wireless speaker, a wireless light, and/or a wireless battery charger have a receiver capable of receiving power from the wireless power transmitter to charge an associated battery.

### PRIORITY CLAIM(S) & RELATED APPLICATION(S)

Priority is claimed to U.S. Provisional Patent Application Ser. No. 62/180,540, filed Jun. 16, 2015; which is hereby incorporated herein by reference in its entirety.

This is related to U.S. patent application Ser. No. 14/802,691, filed Jul. 17, 2017, which claims priority to U.S. Provisional Patent Application Ser. No. 62/026,445, filed Jul. 17, 2014, entitled “Universal Wireless Portable Charger”; which are hereby incorporated herein by reference in their entirety.

### BACKGROUND

Field of the Invention

The present invention relates generally to wireless charging.

Related Art

Electrical devices have become more common and more useful in the past years. The need to keep these devices charged, and the limitations of wired charging, has become more apparent with increased integration of these devices into our daily lives. Wireless power transfer is a convenient method for charging the devices we use daily. Several wireless transfer protocols currently exist, or are being developed, including inductive coupling, resonant inductive coupling, and radio frequency power transfer. Current wireless power transfer methods are typically limited in to low power applications, particularly when transmitting the power over a distance greater than several inches. In addition, wired charging and the increased number of electrical devices can result in unwieldy and unsightly tangles of cords.

### SUMMARY OF THE INVENTION

It has been recognized that it would be advantageous to develop a system to power electrical devices commonly found together, such as on a nightstand, while reducing or eliminating an associated bundle of power cords. In addition, it has been recognized that it would be advantageous to develop a system to provide wireless power transfer in high powered accessories not previously considered for wireless charging, such as: a wireless (e.g. Bluetooth) speaker, a desk-top charger (e.g. cellular/smart phone dock and/or smart watch, a table lamp, a portable battery, a keyboard, a mouse, a flashlight, etc.

The invention provides a wireless charging system, comprising a horizontal support surface and a wireless power transmitter plugged into a power outlet. The wireless power transmitter and the horizontal support surface are located within a predetermined radius of one another. The transmitter is capable of sending energy within the radius, including the horizontal support surface. A plurality of chargeable devices is selectively disposed on the horizontal surface and within the radius. Each of the plurality of chargeable devices is capable of receiving power from the wireless power transmitter without a power cord extending across the horizontal support surface between the charging dock and the wireless power transmitter or the power outlet. Each of the plurality of chargeable devices comprises: 1) a housing; 2) a wireless power receiver disposed in the housing; 3) a rechargeable battery disposed in the housing and coupled to the wireless power receiver; and 4) charger electronics coupled to the wireless power receiver, or the rechargeable battery, or both, to control charging of the rechargeable battery in the housing.

In accordance with a more detailed aspect of the invention, the plurality of chargeable devices can comprise a wireless charging dock capable of receiving and carrying a cellular phone, or a wrist worn device, or both; a wireless speaker; a wireless light; and/or a battery charger configured to more rapidly charge another battery powered device. The rechargeable battery of each of the plurality of chargeable devices can charge continuously at a lower rate from the wireless power transmitter. Each of the plurality of chargeable devices can have a load (e.g. the rechargeable battery of the cellular phone or wrist worn device, speaker, light, etc.) that draws power intermittently from a respective rechargeable battery at a higher rate.

In addition, the invention provides a wireless nightstand system, comprising a horizontal support surface and a wireless power transmitter plugged into a power outlet. The wireless power transmitter and the horizontal support surface are located within a predetermined radius of one another. The transmitter is capable of sending energy via a radio frequency (RF) signal within the radius including the horizontal support surface. A wireless charging dock is selectively disposed on the horizontal surface, and within the radius. The wireless charging dock is capable of receiving and carrying a cellular phone, or a wrist worn device, or both. The wireless charging dock is capable of receiving power from the wireless power transmitter to charge the cellular phone, or the wrist worn device, or both, and without a power cord extending across the horizontal support surface between the charging dock and the wireless power transmitter or the power outlet. The charging dock comprises: 1) a dock housing; 2) a wireless power receiver disposed in the dock housing; 3) a rechargeable battery disposed in the dock housing and coupled to the wireless power receiver; 4) a charger coupling carried by the dock housing and coupled to the rechargeable battery, and configured to be coupled to the cellular phone, or the wrist worn device, or both; and 5) charger electronics coupled to the wireless power receiver, or the rechargeable battery, or both, to control charging of the rechargeable battery in the charging dock.

A wireless speaker is selectively disposed on the horizontal surface and within the radius. The wireless speaker is capable of receiving power from the wireless power transmitter without a power cord extending across the horizontal support surface between the speaker and the wireless power transmitter or the power outlet. The wireless speaker comprises: 1) a speaker housing; 2) a wireless power receiver disposed in the speaker housing; 3) a rechargeable battery disposed in the speaker housing and coupled to the wireless power receiver; 4) a speaker disposed in the speaker housing and coupled to the battery; and 5) charger electronics coupled to the wireless power receiver, or the rechargeable battery in the speaker housing, or both, to control charging of the rechargeable battery in the speaker housing.

Furthermore, the invention provides a wireless charging system comprising a wireless power transmitter plugged into a power outlet. The wireless power transmitter is capable of sending energy within a radius. At least one chargeable device is selectively disposed within the radius, and is capable of receiving power from the wireless power transmitter. The at least one chargeable device comprises: 1) a housing; 2) a wireless power receiver disposed in the housing; 3) a rechargeable battery disposed in the housing and coupled to the wireless power receiver, and charging continuously at a lower rate; and 4) charger electronics coupled to the wireless power receiver, or the rechargeable battery, or both, to control charging of the rechargeable battery in the housing; and 5) a load coupled to the rechargeable battery and drawing power intermittently therefrom at a higher rate.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a schematic view of a wireless charging system;

FIG. 2 is a block diagram of the wireless charging system of FIG. 1; and

FIG. 3 is a schematic view of the wireless charging system of FIG. 1.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definitions

The term “cellular phone” is used broadly herein to refer to any communication device with wireless communication capability, including for example, personal computers (PCs), digital music players (MP3 players), tablets or tablet computers, phablets, etc. Thus, the cellular phone or communication device can connect and communicate over a cellular network. In addition, the cellular phone or communication device can wirelessly couple to a wireless area network, which in turn can couple to a telephone network or line.

The term “wrist worn device” refers to a wrist born device that is securable and carriable around a user's wrist, and capable of communicating with the cellular phone.

The term “charger coupling” refers to a coupling to charge a battery or power a device, and can include a wire, a charging pad, etc. In one aspect, the charger coupling can include a wire, and having proprietary or standard connections on one or both ends, such as USB connections. In another aspect, the charger coupling can include two pads disposable together.

The term “transceiver” is used herein to refer to a transmitter for transmitting a signal, a receiver for receiving a signal, or both a transmitter and a receiver. The transceiver can both send and receive, or can include a transmitter for transmitting a signal, and a receiver for receiving a signal.

### DESCRIPTION

The invention provides a wireless charging system with a wireless power transmitter that can be plugged into a power outlet, such as a standard wall outlet. The wireless power transmitter is capable of sending energy, such as via a radio frequency (RF) signal, within a predetermined radius. In addition, the wireless charging system has one or more chargeable devices selectively disposed within the radius, and capable of receiving power from the wireless power transmitter via a wireless power receiver. In one aspect, the chargeable device itself can contain a rechargeable battery and a load, such as a table lamp or a wireless speaker. In another aspect, the chargeable device can contain a rechargeable battery and a dock to receive a device with a load, such as a wireless charging dock for a cellular/smart phone and/or smart watch. The rechargeable battery charges continuously (while in the radius of the wireless power transmitter, and until fully charged) at a lower rate, such as 1 W or less. The load draws power intermittently from the rechargeable battery at a higher rate, such as greater than 1 W in one aspect, and greater than 10 W in another aspect. The chargeable devices have charger electronics coupled to the wireless power receiver, or the rechargeable battery, or both, to control charging of the rechargeable battery. In addition, the chargeable devices can have load charger electronics coupled to the device (e.g cellular/smart phone or smart watch) to control charging of a rechargeable battery in the device. Furthermore, the chargeable devices can have load control electronics coupled to the load to control operation of the load. The chargeable devices can be selectively disposable on a horizontal support surface, such as a nightstand, and within the radius. The chargeable devices are capable of receiving power from the wireless power transmitter without a power cord extending across the horizontal support surface between the chargeable devices and the wireless power transmitter or the power outlet, so that the horizontal surface is free of power cords disposed thereon.

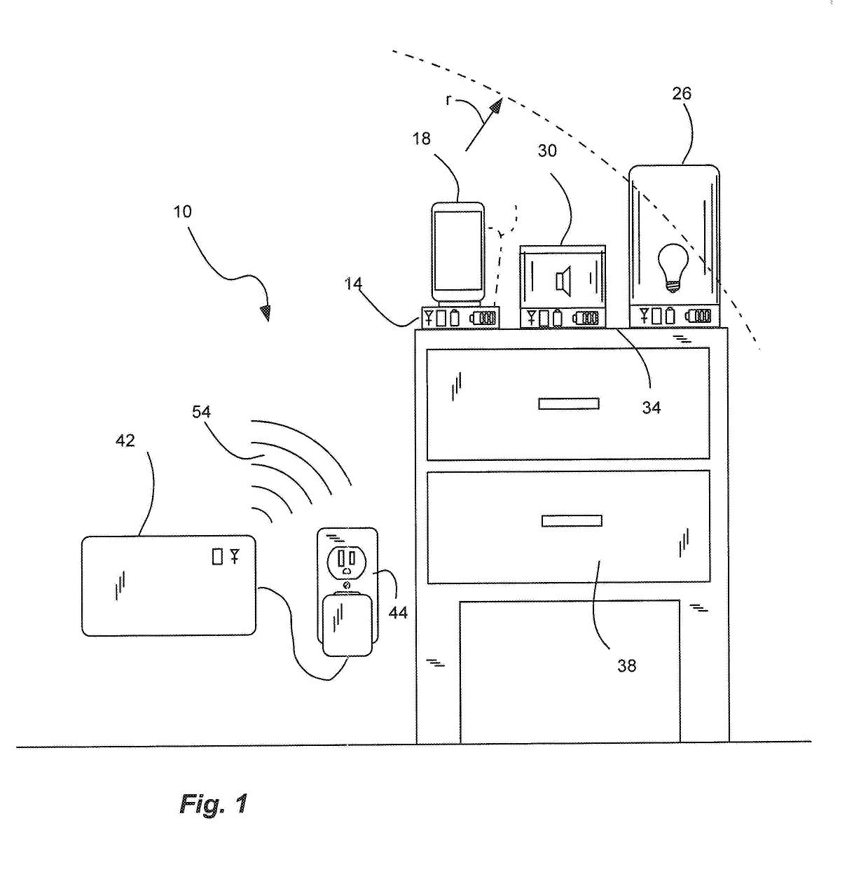

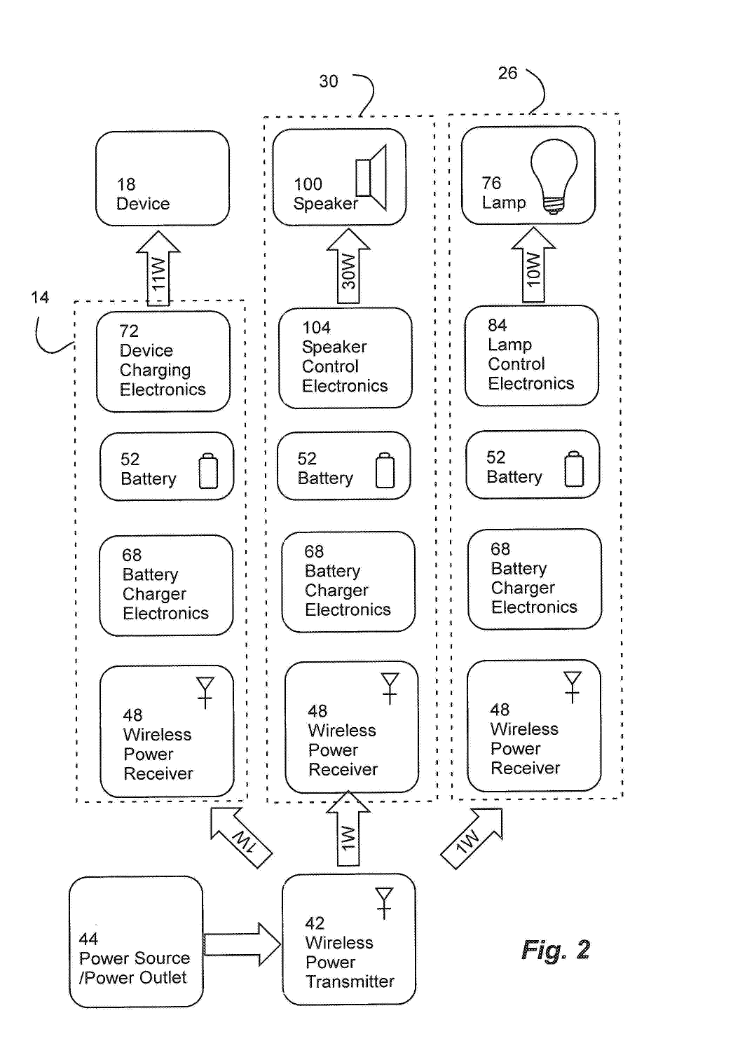

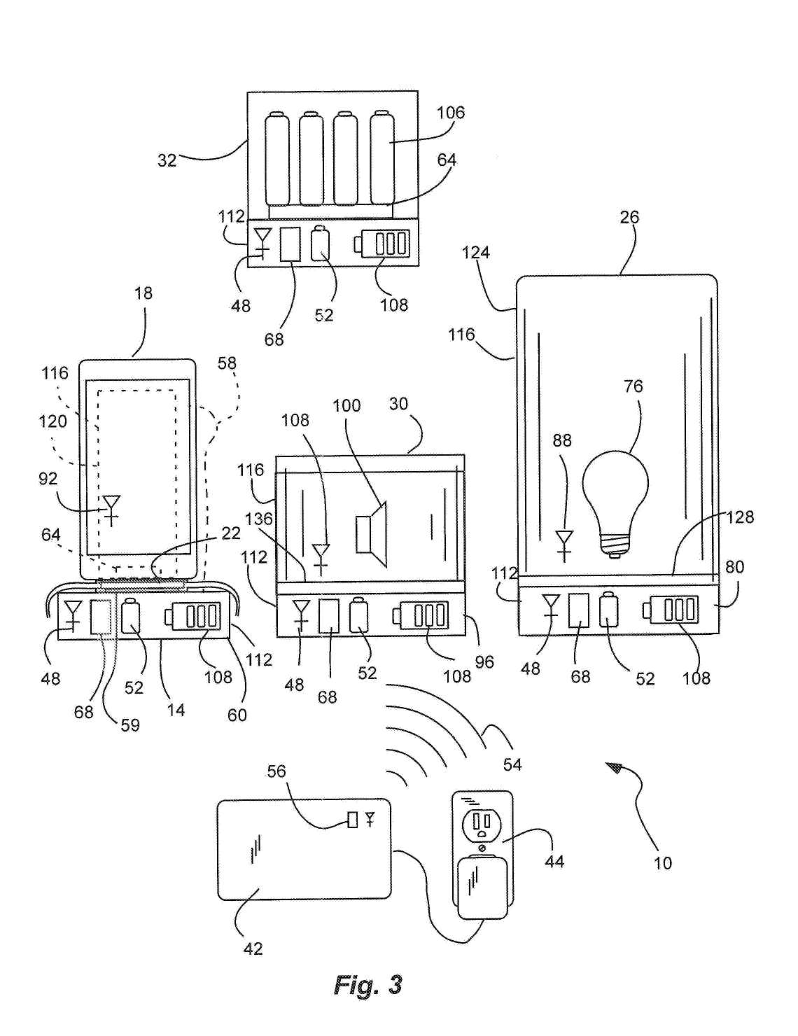

As illustrated in FIGS. 1-3, a system 10 in an example implementation in accordance with the invention is shown for providing wireless power and/or charging to a plurality of chargeable devices that can commonly be used together, including by way of example, a wireless charging dock 14 for a cellular/smart phone 18 and/or wrist worn device 22 (smart watch), a light 26, and a speaker 30. Other chargeable devices can include a battery charger 32, a portable battery, a keyboard, a mouse, a flashlight, etc. In one aspect, such chargeable devices can be disposed on a horizontal support surface 34, such as a nightstand 38. Thus, the system can be a wireless nightstand system to resist the accumulation of excessive power cord on the surface, or on the nightstand.

Power is sent wirelessly from a wireless power transmitter 42 plugged into a power outlet 44 (120V/240V), to a receiver 48 in the chargeable device. This power is used to charge an internal battery 52 in the chargeable device, which provides power to the load at levels higher than can be provided from the wireless power transmitter. The batteries 52 in the chargeable devices are sized such that they will charge completely during the portion of the day that the chargeable devices are typically idle, but still provide enough power for maximum typical daily use. For example, a wireless (e.g. Bluetooth) speaker utilizing this invention can have a battery that is capable of powering the speaker at full volume for 4-6 hours. This battery receives power continuously while the speaker is within range of the transmitter and until the batter is fully charged, and charges over the course of the day, particularly during the times when the speaker is not actively used. In one aspect, the wireless power transmitter 42 can be located close to or adjacent to the horizontal support surface 34, with a power cord extending from the power outlet 44 to the wireless power transmitter. In another aspect, the wireless power transmitter can be plugged directly into the power outlet and carried by the power outlet. In one aspect, the wireless power transmitter 42 can be disposed off of the horizontal support surface 34, and out of sight. In another aspect, the wireless power transmitter 42 can be disposed at a lower elevational height, and thus under or below, the horizontal support surface 34. Thus, the system can reduce clutter.

The system 10 can comprise the horizontal support surface 34, the wireless power transmitter 42, and one or more chargeable devices, such as the wireless charging dock 14, the wireless light 26, the wireless speaker 30, the wireless battery charger 32, the portable battery, the keyboard, the mouse, the flashlight, etc. The wireless power transmitter 42 and the horizontal surface 34 are located within the predetermined radius (r) of one another (and thus the chargeable devices). In one aspect, the transmitter 42 can be capable of sending energy (represented at 54) via a radio frequency (RF) signal within the radius including the horizontal support surface 34. In another aspect, the transmitter can be capable of sending energy via other forms of transmission, such as sonic, laser, electromagnetic, etc. The transmitter 42 can include control electronics 56 to sense and control power transmission from the transmitter, to one or more receivers 48 associated with the chargeable devices. One non-limiting example of a wireless power transmitter, or wireless power delivery system, is the WattUp™ wire free charging system of Energous Corporation of San Jose, Calif.

The wireless charging dock 14 can be selectively disposed on the horizontal surface 34. The charging dock 14 is capable of receiving and carrying a cellular/smart phone 18 and/or a wrist worn device (smart watch) 22 on the horizontal support surface. The charging dock 14 can include a cradle or the like to receive the cellular phone, and to carry the cellular phone at a desired angle for viewing. The cradle can include an upright, inclined platform. In addition, the cradle can have a power and/or data plug (such as charger coupling 64) to mate with a power and/or data port of the cellular phone. In another aspect, the charging dock or cradle or platform can have a charging pad (similar to 59) to receive the cellular phone thereon. In another aspect, the charging dock can have a short wire 58 extending therefrom with a power and/or data plug to mate with the power and/or data port of the cellular phone. The charging dock can also have a receptacle to receive the wrist worn device. In one aspect, the receptacle can have a power and/or data plug (similar to 64) to mate with a power and/or data port of the wrist worn device. In another aspect, the receptacle can have a charging pad 59 to receive the wrist worn device thereon. In another aspect, the charging dock can have a short wire (similar to 58) extending therefrom with a power and/or data plug to mate with the power and/or data port of the wrist worn device. The charging dock 14 can be capable of receiving power from the wireless power transmitter 42 to charge the cellular phone and/or the wrist worn device without a power cord extending across the horizontal support surface between the charging dock and the wireless power transmitter or the power outlet.

The charging dock 14 can comprises: 1) a dock housing 60; 2) a wireless power receiver 48 disposed in the dock housing; 3) a rechargeable battery 52 disposed in the dock housing and coupled to the wireless power receiver; 4) a charger coupling 64 carried by the dock housing and coupled to the cellular phone 18 and/or wrist worn device 22; and 5) charger electronics 68 coupled to the wireless power receiver and/or the battery. In addition, the charging dock can comprise device charging electronics 72 coupled to and/or between the between the battery 52 and the cellular phone 18 and/or wearable device 22 to control charging a battery therein. The charger coupling 64 can comprise a power and/or data plug to mate with a power and/or data port of the cellular phone; a charging pad to receive the cellular phone thereon; a short wire extending 58 therefrom with a power and/or data plug to mate with the power and/or data port of the cellular phone; a power and/or data plug to mate with a power and/or data port of the wrist worn device; a charging pad 59 to receive the wrist worn device thereon; and/or a short wire extending therefrom with a power and/or data plug to mate with the power and/or data port of the wrist worn device, as described above.

The wireless light 26 can be selectively disposed on the horizontal support surface 34. The wireless light 26 is capable of receiving power from the wireless power transmitter 42 without a power cord extending across the horizontal support surface between the light and the wireless power transmitter or the power outlet. The light can include one or more LED lights 76. The light 26 can comprises: 1) a light housing 80; 2) a wireless power receiver 48 disposed in the light housing; 3) a rechargeable battery 52 disposed in the light housing and coupled to the wireless power receiver; 4) a light 76 disposed in the light housing and coupled to the battery; and 5) charger electronics 68 coupled to the wireless power receiver and/or the battery to control charging of the battery in the light. In addition, the light can comprise lamp control electronics 84 coupled to and/or between the between the battery 52 and the light 76 to control the light.

In one aspect, the light can include a transceiver 88 disposed in the light housing 80 and coupled to the battery 52, and capable of communicating with a transceiver 92 of the cellular phone 18 so that the cellular phone can control the light. For example, the cellular phone can include an app or other program that turns on the light when a timed alarm is set. Thus, the user can awake by using an alarm timer on their cellular phone that turns on the light. In addition, the light can have different lights separately operated for different functions. For example, a main body of the light can illuminate for purposes of illumination. As another example, a colored light band extending around the light housing can illuminate in one or more different colors to indicate an alarm, etc.

The wireless speaker 30 can be selectively disposed on the horizontal surface 34. The wireless speaker 50 is capable of receiving power from the wireless power transmitter 42 without a power cord extending across the horizontal support surface between the speaker and the wireless power transmitter or the power outlet. The wireless speaker 30 can comprise: 1) a speaker housing 96; 2) a wireless power receiver 48 disposed in the speaker housing; 3) a rechargeable battery 52 disposed in the speaker housing and coupled to the wireless power receiver; 4) a speaker 100 disposed in the speaker housing and coupled to the battery; and 5) charger electronics 68 coupled to the wireless power receiver and/or the battery to control charging of the battery in the speaker. In addition, the speaker can comprise speaker control electronics 104 coupled between the battery 52 and the speaker 100 to control the speaker. In one aspect, the wireless speaker 30 can have a transceiver 108 disposed in the speaker housing 96 and coupled to the battery 52, and capable of communicating with a transceiver 92 of the cellular phone 18. Thus, the cellular phone can play music through the speaker. In another aspect, the speaker can have a data wire with an audio plug insertable into an audio port on the cellular phone. In another aspect, the cellular phone can control the wireless speaker. For example, the cellular phone can include an app or other program that turns on the speaker, and plays music or an alarm, when a timed alarm is set. Thus, the user can awake by using an alarm timer on their cellular phone that turns on the light and the wireless speaker together.

The battery charger 32 can be similar to the charging dock, and can be disposed on the horizontal support surface 34. The battery charger can be configured to more rapidly charge another battery powered device 106. The another batter powered device 106 can comprise additional rechargeable batteries, a flashlight, a keyboard, a mouse, etc. The battery charger itself can be capable of receiving power from the wireless power transmitter to less rapidly charge the battery charger without any wires extending across the horizontal support surface between the wireless power transmitter and the battery charger. The battery charger 32 can comprise: 1) a battery charger housing; 2) a wireless power receiver 48 disposed in the battery charger housing; 3) a rechargeable battery 52 disposed in the battery charger housing and coupled to the wireless power receiver; 4) a charger coupling 64 coupled to the rechargeable battery and being operatively coupleable to the another battery powered device; and 5) charger electronics coupled to the wireless power receiver and/or the battery. In addition, the battery charger can have battery charging electronics coupled between the battery and the another battery powered device to control charging of the battery in the another battery powered device. In one aspect, the charger coupling can comprise a power cord (similar to 58) removably coupled to a port on the another battery powered device. In another aspect, the charger coupling can comprise a charging pad (similar to 59).

Any or all of the chargeable devices, the charging dock 14, the wireless light 26, the wireless speaker 30 and/or the battery charger can comprise an indicator light 108 to indicate that an associated battery is being charged by the wireless power transmitter 42. In addition, the indicator light 108 can indicate that the chargeable device is within the radius of the wireless power transmitter 42. Furthermore, the chargeable device can have a light to indicate connectivity of the transceiver with the transceiver of the cellular phone.

Any or all of the chargeable devices, the charging dock, the wireless light, the wireless speaker and/or the battery charger can comprise the battery 52 and the wireless power receiver 48 being disposed in a base 112 of an associate housing (60, 80 or 96) and located adjacent a bottom of the associated housing, closer to a bottom than a top thereof, to lower a center of gravity of the housing of the charging dock, the wireless light, the wireless speaker and/or the battery charger to increase stability.

Any or all of the charging dock, the wireless light, the wireless speaker and/or the battery charger can comprise a housing containing a rechargeable battery and a wireless power receiver, and the control electronics. The housings can have a base 112 which can contain the rechargeable battery 52 and the wireless power receiver 48, and the control electronics (68, 72, 84 and/or 104), and a top 116 disposed on and carried by the base to perform an intended function. The bases 112 can be the same size and the same shape so that, in one aspect, the bases can be interchangeable, or in another aspect, facilitate manufacturing. In one aspect, the bases can be circular, or can be discs or pucks. In another aspect, the base can contain a transceiver 88 or 108 to communicate with a transceiver 92 of the cellular phone 18. Thus, the cellular phone 18 can control the function of the charging dock 14, the wireless light 26, the wireless speaker 30 and/or the battery charger. In another aspect, the control electronics can include a transceiver to communicate with the wireless power transmitter.

The charging dock 14 can have the cradle, platform and receptacle 120 disposed on and carried by the base. In one aspect, electrical connections can extend from the battery of the base to the cradle, platform and/or receptacle 120. As described above, in one aspect, the cradle and/or receptacle can have a plug therein or carried thereby to receive a socket of the cellular phone and/or wearable device. In another aspect, an electrical cord with a plug can extend from the base. In another aspect, an electrical cord with a plug can extend from the socket and/or the receptacle. The electrical connection can extend from the battery in the base, to the plug or cord. In one aspect, the base or housing can have or contain a spool therein to receive a charging cord around the spool, and substantially contained in the base of housing.

The wireless light 26 can have a shroud or dome 124 or the like disposed on and carried by the base 80. The shroud or dome 124 can be transparent or at least light translucent. The shroud or dome can be configured to diffuse and/or direct light. In one aspect, the base and/or the shroud or dome can include a reflector to direct or concentrate light. In one aspect, the light can be carried by the shroud or dome. In another aspect, the light can be carried by the base. In another aspect, the shroud or dome can have a sub-base 128 affixed to the shroud or dome, and disposable on and attachable to the base. In one aspect, the light can be carried by the sub-base. An electrical cord can extend from the base to the light, the shroud or dome, and/or the sub-base. As described above, the wireless light can have a plurality of lights. In one aspect, the shroud or dome, or the sub-base or the base, can include a perimeter ring that circumscribes the shroud or dome, or the sub-base or the base, and that can be illuminated by a light. In another aspect, the wireless light can have a shade. In another aspect, the wireless light can have an arm or armature extending from the base or sub-base, and carrying the light. The arm or armature can be fixed or articulated (or bendable).

The wireless speaker 30 can have a shroud or grill 132 or the like disposed on and carried by the base 96. The shroud or grill 132 can be perforated or permeable by sound waves. The shroud or grill can be configured to diffuse and/or direct sound, or even amplify the sound. In one aspect, the base and/or the shroud or grill can include a reflector or shape to direct or concentrate or amplify sound. In one aspect, the speaker can be carried by the shroud or grill. In another aspect, the speaker can be carried by the base. In another aspect, the shroud or grill can have a sub-base 136 affixed to the shroud or grill, and disposable on and attachable to the base. In one aspect, the speaker can be carried by the sub-base. An electrical cord can extend from the base to the speaker, the shroud or grill, and/or the sub-base. The wireless speaker can have a plurality of speakers or sound transducers.

The battery charger can have the cradle, platform, receptacle and/or pad disposed on and carried by the base. In one aspect, electrical connections can extend from the battery of the base to the cradle, platform, receptacle and/or pad. In one aspect, an electrical cord with a plug can extend from the base, or a sub-base thereof. The electrical connection can extend from the battery in the base, to the plug or cord.

In another aspect, the bases 112 can be configured to receive other functional units or accessory, including flashlights, MP3 or digital music players, headphones, wireless headphones, wireless earbuds, watches, tablet computers, phablets, security monitors, remote controls, cameras, cordless phones (associated with a landline), computers, computer input devices (keyboards and/or mice), radios, two-way radios (walkie talkies), GPSs, drop camera or security camera, etc. that can be removably disposed on the bases. The bases, or sub-bases, can be configured (shaped and sized) to receive the associated functional unit or accessory.

In another aspect, the horizontal support surface 34 can be or can be provided by a desk or shelf.

In one aspect, the system 10 can be provided as a package, with the wireless power transmitter 42 and one or more of the chargeable devices, such as the charging dock, the wireless light, the wireless speaker and/or the battery charger.

In one aspect, the chargeable devices, the charging dock, the wireless light, the wireless speaker and/or the battery charger can form or can be accessories to the wireless power transmitter. The wireless power transmitter can define a base unit with the accessories forming satellite units associated with and being disposed in the operable radius of power transmission of the base unit. In one aspect, the accessories or satellite units can remain with the operable radius of the transmitter or base unit. In another aspect, one or more of the accessories or satellite units can be removably disposed in the operable radius.

Other chargeable devices, accessories or satellite units can include flashlights, MP3 or digital music players, headphones, wireless headphones, wireless earbuds, watches, tablet computers, phablets, security monitors, remote controls, cameras, cordless phones (associated with a landline), computers, computer input devices (keyboards and/or mice), radios, two-way radios (walkie talkies), GPSs, drop camera or security camera, etc., and any associated base.

In one aspect, the functional units or accessories, or the accessories or satellite units, can be configured to rapidly charge from the associated base of the chargeable device, while the base of the chargeable device is configured to less rapidly charge from the wireless power transmitter. In another aspect, the functional units or accessories, or the accessories or satellite units, can be configured to charge directly from the wireless power transmitter, without an associated base. Thus, the functional units or accessories, or the accessories or satellite units, can have wireless power receiver incorporated therein, or disposed in the housings thereof.

In one aspect, the functional units or accessories, or the accessories or satellite units, can be configured to act as the wireless power transmitter, or can include the wireless power transmitter therein, and can be plugged into the power source. For example, the light can be plugged into the power source and can include the wireless power transmitter. In another aspect, the wireless power transmitter can include one or more of the functional units or accessories, or the accessories or satellite units. For example, the wireless power transmitter can include a light, etc.

In another aspect, the support surface can be vertical, or can be a vertical support surface.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A wireless nightstand system, comprising:
a) a horizontal support surface;
b) a wireless power transmitter plugged into a power outlet, the wireless power transmitter and the horizontal support surface being located within a predetermined radius of one another, the transmitter being capable of sending energy via a radio frequency (RF) signal within the radius including the horizontal support surface;
c) a wireless charging dock selectively disposed on the horizontal surface and within the radius, the wireless charging dock capable of receiving and carrying a cellular phone, or a wrist worn device, or both, the wireless charging dock being capable of receiving power from the wireless power transmitter to charge the cellular phone, or the wrist worn device, or both, without a power cord extending across the horizontal support surface between the charging dock and the wireless power transmitter or the power outlet, the charging dock comprising:
i) a dock housing;
ii) a wireless power receiver disposed in the dock housing;
iii) a rechargeable battery disposed in the dock housing and coupled to the wireless power receiver;
iv) a charger coupling carried by the dock housing and coupled to the rechargeable battery, and configured to be coupled to the cellular phone, or the wrist worn device, or both; and
v) charger electronics coupled to the wireless power receiver, or the rechargeable battery, or both, to control charging of the rechargeable battery in the charging dock; and
d) a wireless speaker selectively disposed on the horizontal surface and within the radius, and being capable of receiving power from the wireless power transmitter without a power cord extending across the horizontal support surface between the speaker and the wireless power transmitter or the power outlet, and comprising:
i) a speaker housing;
ii) a wireless power receiver disposed in the speaker housing;
iii) a rechargeable battery disposed in the speaker housing and coupled to the wireless power receiver;
iv) a speaker disposed in the speaker housing and coupled to the battery; and
v) charger electronics coupled to the wireless power receiver, or the rechargeable battery in the speaker housing, or both, to control charging of the rechargeable battery in the speaker housing.

2. The system in accordance with claim 1, wherein the wireless power transmitter is disposed off of the horizontal support surface.

3. The system in accordance with claim 1, wherein the wireless speaker further comprises:
a transceiver disposed in the speaker housing and coupled to the battery and capable of communicating with a transceiver of the cellular phone.

4. The system in accordance with claim 1, further comprising:
a wireless light selectively disposed on the horizontal surface and being capable of receiving power from the wireless power transmitter without a power cord extending across the horizontal support surface between the light and the wireless power transmitter or the power outlet, and comprising:
i) a light housing;
ii) a wireless power receiver disposed in the light housing;
iii) a rechargeable battery disposed in the light housing and coupled to the wireless power receiver;
iv) a light disposed in the light housing and coupled to the battery; and
v) charger electronics coupled to the wireless power receiver, or the rechargeable battery in the light housing, or both, to control charging of the rechargeable battery in the light housing.

5. The system in accordance with claim 4, wherein the wireless light further comprises:
a transceiver disposed in the light housing and coupled to the battery and capable of communicating with a transceiver of the cellular phone so that the cellular phone can control the light.

6. The system in accordance with claim 1, further comprising:
a battery charger configured to more rapidly charge another battery powered device, the battery charger being selectively disposed on the horizontal surface and capable of receiving power from the wireless power transmitter to less rapidly charge the battery charger without a power cord extending across the horizontal support surface between the battery charger and the wireless power transmitter or the power outlet, the battery charger comprising:
i) a battery charger housing;
ii) a wireless power receiver disposed in the battery charger housing;
iii) a rechargeable battery disposed in the battery charger housing and coupled to the wireless power receiver;
iv) a charger coupling coupled to the battery and being operatively coupleable to the another battery powered device; and
v) charger electronics coupled to the wireless power receiver, or the rechargeable battery in the battery charger housing, to control charging of the rechargeable battery in the battery charger housing.

7. The system in accordance with claim 6, wherein the charger coupling comprises a power cord removably coupled to a port on the another battery powered device.

8. The system in accordance with claim 6, wherein the charger coupling comprises a wireless charging pad.

9. The system in accordance with claim 1, wherein the charging dock, or the wireless speaker, or both, further comprises:
an indicator light to indicate that an associated battery is being charged by the wireless power transmitter.

10. The system in accordance with claim 1, wherein the charging dock, or the wireless speaker, or both, further comprises:
the rechargeable battery and the wireless power receiver being disposed in a base of an associate housing and located adjacent a bottom of the associated housing closer to a bottom than a top thereof.

11. The system in accordance with claim 1, wherein the rechargeable battery of the wireless charging dock and the rechargeable battery of the wireless speaker charge continuously at a lower rate from the wireless power transmitter; and wherein the cellular phone, or the wrist worn device, or both, of the wireless charging dock, and the speaker of the wireless speak, draw power intermittently from a respective rechargeable battery at a higher rate.

12. A wireless charging system, comprising:
a) a horizontal support surface;
b) a wireless power transmitter plugged into a power outlet, the wireless power transmitter and the horizontal support surface being located within a predetermined radius of one another, the transmitter being capable of sending energy within the radius including the horizontal support surface;
c) a plurality of chargeable devices, each selectively disposed on the horizontal surface and within the radius, each of the plurality of chargeable devices being capable of receiving power from the wireless power transmitter without a power cord extending across the horizontal support surface between the charging dock and the wireless power transmitter or the power outlet, each of the plurality of chargeable devices comprising:
i) a housing;
ii) a wireless power receiver disposed in the housing;
iii) a rechargeable battery disposed in the housing and coupled to the wireless power receiver; and
iv) charger electronics coupled to the wireless power receiver, or the rechargeable battery, or both, to control charging of the rechargeable battery in the housing.

13. The system in accordance with claim 12, wherein the plurality of chargeable devices comprises:
a wireless charging dock capable of receiving and carrying a cellular phone, or a wrist worn device, or both; and
a wireless speaker.

14. The system in accordance with claim 13, wherein the plurality of chargeable devices comprises:
a wireless light.

15. The system in accordance with claim 12, wherein the plurality of chargeable devices comprises:
a battery charger configured to more rapidly charge another battery powered device.

16. The system in accordance with claim 12, wherein the rechargeable battery of each of the plurality of chargeable devices charges continuously at a lower rate from the wireless power transmitter; and wherein each of the plurality of chargeable devices has a load that draws power intermittently from a respective rechargeable battery at a higher rate.

17. A wireless charging system, comprising:
a) a wireless power transmitter plugged into a power outlet, the wireless power transmitter being capable of sending energy within a radius; and
b) at least one chargeable device selectively disposed within the radius and capable of receiving power from the wireless power transmitter, the at least one chargeable device comprising:
i) a housing;
ii) a wireless power receiver disposed in the housing;
iii) a rechargeable battery disposed in the housing and coupled to the wireless power receiver, and charging continuously at a lower rate; and
iv) charger electronics coupled to the wireless power receiver, or the rechargeable battery, or both, to control charging of the rechargeable battery in the housing; and
v) a load coupled to the rechargeable battery and drawing power intermittently therefrom at a higher rate.

18. The system in accordance with claim 17, wherein
a) the least one chargeable device is selectively disposable on a horizontal support surface; and
b) the at least one chargeable device is capable of receiving power from the wireless power transmitter without a power cord extending across the horizontal support surface between the at least one chargeable device and the wireless power transmitter or the power outlet.

19. The system in accordance with claim 17, wherein the at least one chargeable device comprises:
a wireless charging dock capable of receiving and carrying a cellular phone, or a wrist worn device, or both, the charging dock comprising:
a charger coupling carried by the dock housing and coupled to the rechargeable battery, and configured to be coupled to the cellular phone, or the wrist worn device, or both.

20. The system in accordance with claim 17, wherein the at least one chargeable device comprises:
a wireless speaker comprising:
a speaker.
